(19) United States
(12) Patent Application Publication
(10) Pub. No.: US 2026/0212848 A1
(43) Pub. Date: Jul. 23, 2026

(54) AI POWERED DIGITAL AUDIO WORKSTATION USING QUANTUM ALGORITHM

(71) Applicant: Orlando A. Brooks, JR., Coatsville, PA (US)

(72) Inventor: Orlando A. Brooks, JR., Coatsville, PA (US)

(21) Appl. No.: 19/299,225

(22) Filed: Aug. 13, 2025

Related U.S. Application Data
(60) Provisional application No. 63/659,361, filed on Jun. 13, 2024.

(51) Int. Cl. G10H 1/00; G06N 10/20

(52) U.S. Cl. CPC G10H 1/0025; G06N 10/20; G10H 2250/311

(57) ABSTRACT

An AI-powered multimedia workstation integrates a digital audio workstation (DAW), visual graphics editor, and office productivity tools within a single platform. Operating on an AI/quantum-inspired software system, it performs real-time audio, visual, and data processing. A central AI/Quantum Content DNA Engine enables structural, stylistic, and semantic analysis, separation, and manipulation of multimedia content, including audio, video, images, and text. The workstation features a hybrid control surface with dynamic haptic feedback faders, high-resolution touch displays, and professional audio input/output interfaces. AI functions include automated music composition, intelligent mixing and mastering, cross-modal content generation, and context-aware workflow assistance. Quantum-inspired algorithms accelerate rendering, simulation, and large-scale data analysis. The system supports real-time global collaboration via high-speed network protocols and cross-platform compatibility with external devices and software. By combining AI-assisted and quantum-inspired processing, the workstation enhances creative production, performance, and productivity, providing an integrated environment for professional audio, visual, and office applications.

### BACKGROUND OF THE INVENTION

The disclosure generally relates to software and devices for producing, recording, and editing audio recordings and performances, and more particularly to multimedia productions using fully integrated digital audio workstations having a general purpose computing environment which uses AI to power quantum algorithms.

### SUMMARY OF THE INVENTION

The present invention disclosure is directed to methods, systems, and apparatuses for multimedia production, visual design, audio engineering, and professional creative productivity. It integrates four powerful modules into a single workstation: an Al/Quantum-Powered Multimedia Workstation, an Al/Quantum Visual Graphics Editor, an Al/Quantum-powered Digital Audio Workstation, and an Al-Powered Office Productivity Module, all within a single, cohesive platform. A core innovation is the integrated Al/Quantum Content DNA Engine, enabling deep structural, stylistic, and semantic analysis and separation of audio, visual, and textual/data content.

The inventive method and apparatus include: Unified Creative & Productivity Environment: Offers a seamless, integrated platform for a wide array of tasks, including professional audio mastering and music production, comprehensive video editing, advanced graphic design, 2D/3D animation, sophisticated 3D modeling, and a full suite of Al-enhanced office productivity tools (word processing, spreadsheets, presentations, and more).

Al-Driven Assistance, Generation & Content Intelligence: Employs artificial intelligence at every stage, from automated audio mixing and intelligent content generation (visuals from text prompts, Al-assisted composition, Al-assisted document creation) to Al-powered style transfer, predictive workflow assistance, and deep content “DNA” analyzation and separation across all modules for unprecedented understanding and manipulation of creative and office assets.

Quantum-Inspired Performance: Leverages quantum-inspired algorithms to accelerate computationally intensive processes like rendering complex 3D scenes, simulations, advanced data analytics, complex “DNA” feature extraction, and audio-visual data analysis, enabling real-time manipulation and feedback.

Next-Generation Interaction: Designed for intuitive user interaction with Al partners that understand artistic style and professional context, offering real-time feedback and assistance, fostering new forms of collaboration between human creativity/productivity and artificial intelligence.

Cross-Platform Compatibility & Integration: Ensures broad compatibility and aims for seamless integration with various hardware and software ecosystems, including deep interoperability between creative and office modules, facilitated by the Content DNA Engine.

Robust Security: Incorporates advanced security measures, potentially including Al-driven threat detection, ethical Al frameworks, and content obfuscation/provenance techniques to protect creative assets and sensitive office documents.

The digital audio workstation (DAW) of the invention is a platform for state-of-the-art music creation, dynamic live performance, and seamless global collaboration. This workstation keyboard redefines conventional designs by fusing a hardware interface with a dedicated Al/Quantum Software Operating System. It features a hybrid control surface with Dynamic Haptic Feedback Faders (DHFFs), deeply embedded Al pervading every stage of the creative workflow (composition, sound design, mixing, performance), expandable high-resolution audio capabilities (with 8 analog inputs/outputs with inserts, and extensive next-generation USB-C audio streaming), and a globally accessible virtual studio room operating via the RAVIN Protocol over multi-gigabit Ethernet.

This DAW module acts as the integrated hub for diverse creative projects:
Unified Creative Hub: Seamlessly combines tools for professional video editing, audio production, graphic design, 2D/3D animation, 3D modeling, and integration with the Office Productivity Module for project documentation and reporting.

Cross-Modal Al Content Tools: Utilizes Al to work across different media types, enabling innovative functions like generating visual elements from audio data or creating soundscapes based on visual input with high semantic coherence.

Al/Quantum Content DNA Engine Integration: Leverages the central DNA engine for deep analysis of multimedia projects, allowing for sophisticated content deconstruction (e.g., separating video into scenes, shots, and identifiable visual/audio elements based on their “DNA”), element tracking across different media types (e.g., identifying all visual scenes featuring a specific audio motif's “DNA”), and advanced content-aware search.

Al-Accelerated Workflow: Employs Al to automate and assist in complex tasks such as intelligent video scene editing (e.g., automated rough cuts based on narrative analysis), automated content tagging based on extracted “DNA” characteristics, and smart project organization with predictive asset suggestions.

Quantum-Inspired Processing: Leverages quantum-inspired algorithms to drastically reduce processing times for demanding tasks like complex physics simulations for visual effects, multi-layered video rendering with real-time previews, and large-scale data analysis for identifying patterns in user-generated content libraries.
Integrated Collaboration Platform: Features Al-enhanced tools for team collaboration, including shared workspaces with granular permissions, Al-mediated version control that understands semantic changes, and intelligent task management that integrates with the Office Productivity Module.

### AI/Quantum Visual Graphics Editor Module

This module focuses on next-generation visual creation and manipulation:
Al-Driven Image Generation: Create novel images, illustrations, and concept art directly from text descriptions, sketches, audio input, or by combining various visual prompts using advanced generative Al models (e.g., GANs, Diffusion Models).

Intelligent Style Transfer & Visual DNA Analysis: Apply artistic styles from any source with deep semantic understanding. The Al/Quantum Content DNA Engine allows for extraction, analysis, and cataloging of stylistic “DNA” (e.g., brush stroke patterns, color palettes, lighting techniques, compositional rules, texture characteristics) from existing artworks or visual media. This “DNA” can then be modified, blended, or transferred to new creations with fine-grained control and contextual appropriateness.

Advanced Object & Layer Separation via DNA Deconstruction: Beyond simple segmentation, the DNA engine facilitates deep deconstruction of images and videos into fundamental layers, separating objects from backgrounds, or even distinct elements within complex objects (e.g., separating a person from their clothing, or a specific texture from an object) based on their unique visual characteristics and contextual understanding.

Quantum-Accelerated 3D Graphics: Experience significantly faster rendering of complex 3D models, scenes, and visual effects, including real-time ray tracing and global illumination, enabled by quantum-inspired algorithms.

AI Object Intelligence: Automatically recognize, segment, track, and manipulate objects within images and videos with high precision, including context-aware inpainting and smart object removal.

Procedural Content Creation with DNA Control: Utilize Al to procedurally generate textures, patterns, and 3D assets, with the ability to guide and constrain the generation process using extracted or defined visual “DNA” parameters for highly specific and controllable outputs.

### AI/Quantum-Powered Digital Audio Workstation (DAW) Module

This module concerns music production and audio engineering:
AI Music Composition & Arrangement: Collaborate with an AI partner that assists in songwriting by generating melodies, harmonies, rhythms, and even full arrangements based on user style, mood, lyrical themes, or musical theory inputs.

Audio DNA Analysis & Source Separation: The Al/Quantum Content DNA Engine enables advanced, high-fidelity source separation (e.g., isolating vocals, drums, bass, piano, and other instruments from a mixed stereo or multi-track recording). It can also analyze and extract the “timbral DNA” (core sonic characteristics), harmonic structure, rhythmic groove patterns (“groove DNA”), and expressive performance nuances (e.g., vibrato style, dynamic phrasing) of specific instruments or vocalists.

Quantum-Enhanced Sound Design & Synthesis: Explore new sonic territories by manipulating extracted audio “DNA” elements, or by using quantum-inspired audio synthesis techniques to generate unique timbres and textures. Includes advanced physical modeling with quantum-level accuracy for acoustic instrument emulation.

Real-Time AI Performance Coach: Receive intelligent feedback during recording or live performance on aspects like pitch accuracy, rhythmic precision, dynamic consistency, and even expressive delivery, with suggestions for improvement.

AI Mixing & Mastering Assistant: Achieve professional-grade audio clarity and balance through AI tools that analyze multi-track projects, identify psychoacoustic issues, and suggest (or automatically apply) optimal EQ, compression, spatialization, and mastering chain settings tailored to genre and desired loudness.

Context-Aware Audio Editing: Benefit from AI that understands musical structure (sections, chords, beats) and semantic content (instrument types, vocal lines), enhanced by DNA analysis for precise isolation, manipulation, and restoration of sonic elements, including Al-powered de-noising and de-reverberation.

### Al-Powered Office Productivity Module

This module integrates a full suite of Al-enhanced office tools, seamlessly connected with the creative modules and leveraging the Content DNA Engine:
Intelligent Word Processor:

AI-assisted Writing & Document DNA Analysis: Real-time grammar, style, tone, and readability suggestions. The Al/Quantum Content DNA Engine analyzes documents to identify core thematic structures, authorial style “DNA” (vocabulary, sentence structure, rhetorical devices), argumentation patterns, and sentiment, offering insights for targeted revisions, summarization, or style adaptation.

Content Generation & Transformation: Al drafts sections of documents, executive summaries, or rewrites text for different audiences or purposes based on prompts or source material from other suite modules (e.g., generating marketing copy from project descriptions, or a technical script from a video timeline).

Seamless Integration: Directly embed, link, and live-update creative assets (images, audio clips, video stills, 3D model views) from other modules.

Generate scripts, project narratives, or documentation that dynamically links to multimedia timelines and asset libraries.

Advanced Spreadsheet Program (e.g., “Artelligence Sheets”): AI for Data Analysis & Data DNA: Automated pattern recognition, anomaly detection, trend analysis, and predictive forecasting from complex datasets. The DNA engine can identify complex interrelationships, structural “DNA” within datasets, and suggest novel ways to model or visualize data.

Natural Language Querying: Interact with data using plain language to generate insights, pivot tables, and visualizations without complex formulas.

Intelligent Chart & Graph Generation: Al suggests optimal and contextually relevant visualizations for data storytelling.

Integration: Pull data from project management tools, generate budgets, track creative project metrics, or link spreadsheet data to drive parameters in creative modules (e.g., animation values, procedural generation inputs).

Dynamic Presentation Software: AI-Assisted Design & Content: Intelligent slide layout suggestions, automated generation of visually consistent templates based on branding guidelines, and AI assistance in drafting presentation text or suggesting imagery (from creative modules or integrated stock libraries).

Presentation DNA & Reconstruction: AI analyzes the structure, flow, and stylistic “DNA” of successful presentations to offer templates or to help users reconstruct existing presentations with improved narrative flow or visual impact.

Interactive Elements: Embed dynamic, interactive content from other suite modules, such as playable video clips with custom controls, interactive 3D models, or audio snippets with synchronized transcriptions.

AI Delivery Coach: Provides real-time or post-rehearsal feedback on presentation delivery, pacing, clarity, and audience engagement (if webcam/mic input is enabled).
Unified Productivity Hub Features:

AI-Powered Note-Taking & Knowledge Organization: A centralized note-taking application that uses Al for automatic tagging, thematic clustering based on “note DNA,” summarization, and linking notes to relevant project assets or documents across the suite.

Secure Document Management: Robust version control, cloud synchronization, and secure sharing options for all office documents, with AI-assisted categorization and search.

Advanced Collaborative Editing: Real-time co-authoring tools for all office applications, featuring Al-mediated comment summarization, intelligent task tracking derived from document annotations, and suggested resolutions for conflicting edits.

Integration with Project Management: Seamlessly link office documents, tasks, and communications to the suite's unified project management system.

In another aspect of the invention, a Wireless USB-C Multi-Display and Peripheral Expansion System useful with the multimedia production system of the present invention. The multi-display system addresses the growing need for flexible and clutter-free workspace solutions in an era dominated by USB-C enabled devices. While USB-C offers a versatile single-cable solution for data, display, and power, current multi-display and peripheral expansion setups predominantly rely on wired docks and adapters, which restrict mobility and create cable management challenges. This invention introduces a novel wireless system that leverages the capabilities of USB-C to liberate users from these physical tethers. The core of the invention is a transmitting adapter that interfaces with a USB-C source device. This adapter wirelessly broadcasts video (up to 8K resolution), audio, and USB peripheral data to multiple independent receiver units connected to display devices (supporting four or more displays). The system uniquely provides both extended and mirrored display functionalities across these wireless displays and integrates USB peripheral connectivity, all managed through a combination of high-bandwidth Wi-Fi and other wireless protocols like Bluetooth. Powering flexibility for the transmitting adapter (either from the source device via USB-C PD or an external source) and compatibility with various display interfaces through standard adapters further enhance its universality and user convenience. This invention aims to provide a seamless, high-performance, and truly wireless multi-monitor and peripheral hub experience.

### BRIEF DESCRIPTION OF DRAWINGS

FIG. 1 is a plan view of the environment in which the invention is practiced including the workstation of the invention.

FIG. 2 is a plan view of a musical keyboard/mixer assembly used with the present invention.

FIG. 3 is a perspective view of the environment in which the invention is practiced.

### DETAILED DESCRIPTION OF THE INVENTION

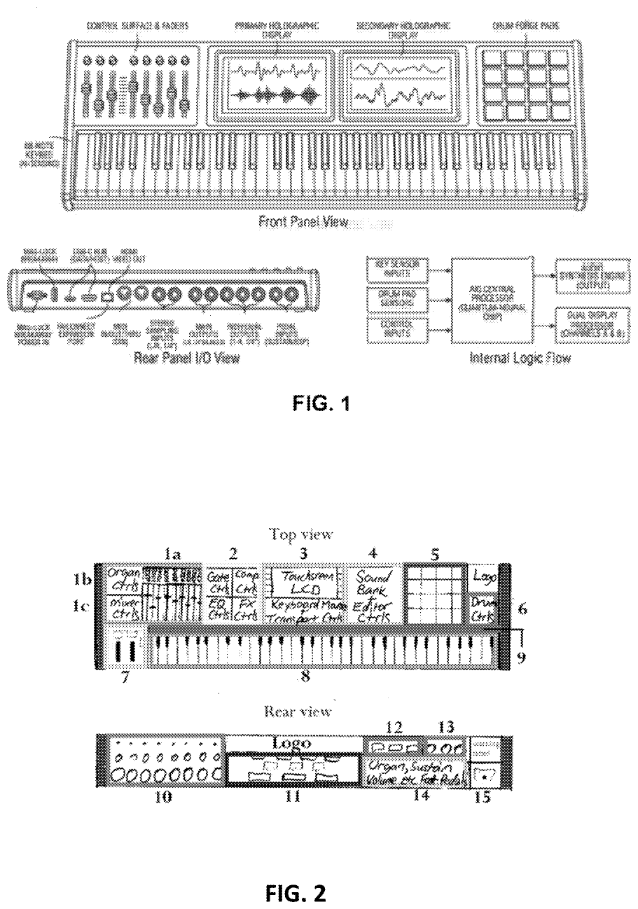

The present invention disclosure is directed to a multimedia system for producing, recording, and editing audio recordings and performances, as well as documents and other creative works. A component of the system is the DAW integrated workstation. The system environment is shown in FIGS. 1 and 2. The system 10 is an AI powered studio or live music keyboard and drum machine, synthesizer, and samplers for use in the music and video entertainment industry. The device includes automated mixer faders 1c, organ controls 1 band rotary knobs 2, 4 for DAW parameter controlling, USB in and out ports 11, and HDMI ports. The system provides users with AI powered music entertainment equipment.

There are multiple HDMI display ports 12 and all solid-state memory and hard drives with expansion abilities. Its CPU or ROM is programmed with AI architecture to work as the total brain for the devices, but with sounds, synthesizers and samples, fix, different music genres and more. There are 32 bit/384 khz analog/digital backwards compatible converters on all device inputs and outputs as well as optical 8 channel input/output, with ADAT backwards compatibility. There can be sample rate conversion downgrade/upgrade capability. There is also a musical keyboard 8 with a tablet holder.

1The inventive Music Network Station is an extraordinary new branch in music keyboards technology. It presents total sound control, networking and development at the user's fingertips. With its Ethernet or Wi-Fi options, Apple's Thunderbolt 3 protocol, this keyboard has the ability to communicate between different network systems such as HiQNET Audio Architect protocol, ADANTE protocol, Microsoft Windows, Apple, and Android via WI-FI, LAN, Bluetooth, and other network/Ethernet protocols. The Music Network Station can connect and communicate with all sorts of equipment, running the same technology, such as, speakers, headphones, mixing consoles, stage boxes, Digital Audio Workstations (DAW), network servers, computer systems, and many other devices. This stand-a-lone Music Network Station features prestige on-board multi-core CPU processors to handle mass production, manipulation of high quality sounds, fx processing, mixing, editing, and all data processing, in sync with Solid State Drive or flash architecture-Operating System boot up and functioning, that can talk with Apple, Microsoft, and Android based platforms. The Music Network Station itself won't run Windows or Apple Operating System, unless advised, but it will be able to boot in a way to recognize, communicate cross platforms onto every Apple based, MS Windows based, and Android based software, allowing it to be integrated with any and every music software, apps or DAW of user's choice. In other words, this Music Workstation will have a bootable Operating System that can communicate cross platform to everyone.

Additional external software can be created to either synchronize and/or control the Music Network Station's onboard functions and features, given it a universal user interface for Apple, MS Windows and Android based products, such as, all hardware then software based products, like Digital Audio Workstations (DAW), Synthesizers, Samplers and FX software or apps. The Operating System that boots for the Music Network Station will be built into the Music Network Station, on a Solid State Drive or ROM with an Automated Recovery Feature, while the User Interface, Utilities Tools software will be packaged with the Music Network Station and will be able to run on Windows, Android and Apple platforms. The Operation System itself for the Music Network Station will be upgradable as firmware or software improves. In addition to the Operating System will be the External Utilities Software and these programs will be able to run and manipulate the Music Network Station to adjust and perform all onboard features and files, such as, all synthesized and sample sounds and sound banks, the dedicated onboard and universal sampler translator and converter, drawbar organ, drum machine, sound editor, 32/64-bit audio and midi multitrack recorder, 32/64-bit audio interface, mixing console and digital FX sections. Along with these features, there will be control over the multi-view HDMI ports as well. You will have 4 HDMI ports. The first HDMI port will display the sound engine and sampler of the Music Network Station. We will call this view the sound bank/editor screen. The second will show on display the audio/midi multi-tracker view of the Music Network Station. The third HDMI port will show the audio/mixer section. You will see a multi-channel mixer that can control every sound, midi instrument or FX input you manipulate as well as the optional add-on audio interface inputs and outputs. The Utilities or User Interface software will control the software points and hardware points of the Music Network Station. It will also control the onboard Ethernet HiQNet Audio Architect and/or Adante, Bluetooth, and Thunderbolt 3 protocols. Basically it will control all of the outputs whether it is Thunderbolt 3, LAN, MIDI, HDMI, DIGITAL, SPDIF/AES and your XLR-¼ inch jacks. Another feature of this Music Network Station is the onboard breath controller where a woodwind instrument player will be able to connect its electronic breath controller up to the Music Network Station and trigger the Music Network Station from his/her electronic instrument. The Music Network Station will also have other software and/or functionality designed for other cutting-edge MIDI controls for guitar and other instruments with MIDI technology. Moreover, there will be a microphone input for its very own built-in Vocoder and plug-ins.

The Music Network Station will have its own external server based online virtual studio room that will allow users to collaborate in a live studio session with each other's using a server based mainframe with written software that will be hosted by the Music Network Station's licensing company via personal accounts, through paid subscriptions online. This software/app will be called “Centourium” Virtual Online Studio Room. It will be able to record, edit, manipulate and playback audio, with video synchronization along with its user interface programming with in-app optional purchased plug-ins. The Virtual Studio Room will be able to communicate all Apple, MS Windows, Android file languages, such as AU, DX, VST, iOS stuff and many more available. It will have connectivity from external devices such as music equipment or video equipment through LAN, Thunderbolt 3 and HDMI (audio/video) protocols and another external invention called “Centourium” A/V Interface Box, which can be wired via Ethernet, Wi-Fi, Bluetooth, or Thunderbolt 3 to the designated computer, tablet or smart device connected to the host server.

An optional organ footboard will also be made available for the drawbar organ feature. There are several accessories that can be designed for revenue off of the initial “Music Network Station”, such as network hubs, sample sound collections, flash and hard drive devices, breath controllers, auxiliary keyboard section for 2^{nd} level Hammond B3 organ style playing, as well as casing to enclose both keyboards together, etc.

The “Centourium” Music Network Station is suitable for all live/studio music performers, producers, engineers, musical directors, DJ s, bands, school instructors/students and anyone wanting to create with great expectations, not to mention all the extra external gear that could be designed to accompany future concepts. With all of the different outputs, the Music Network Station can really talk to a vast number of devices with respect to the port that it's utilizing.

For all of the tablet and smart device users, all of this interfacing can be accomplished through written apps and software, including smart TV users as well. They would just have to be backwards compatible to previous OS like iOS, Apple OS, Android versions, and MS Windows versions.

The Virtual Studio Room will have affiliation with Music Industry Businesses for finished song submissions of qualified subscribers. A company example would be like “TAXI”. They request movie genres for movies, TV, radio and etc.

The components as shown in FIGS. 1 and 2 are now described.

Component 1 is the Automated Mixer/Drawbar Organ/Vocoder/Breath Controller Section:
a) Hybrid Automated Motorize Mixing Console/Drawbar Organ Interface Control Section: It allows you to manipulate the mixer section of the keyboard which controls the faders and audio tracks, volume PAN left or right. It also has a switch button that allows you to control the drawbar organ section. As an example, the drawbar on a Hammond B3 organ.
b) Automated Drawbar Organ Preset Control Section: Actual selection buttons to 1A. So to be able to switch between the different modes, because it is a hybrid, the switch from the automated mixer to the drawbar section, 1b has organ controls that do that.
c) Automated Mixing Console Preset Control Section: Has mixing controls that switch the organ drawbars to the automated motorized mixer portion.
d) Vocoder Section: Vocal control by keyboard manipulation.
e) Breath Controller Section: Enables sound control from horn instruments.

Component 2 is the Automated Audio/MIDI Channel Mixing Effect Section: Channel Strip (Compressor, Gate/Limiter, EQ and Digital FX Processors).

This section goes along with the mixer and the sound bank parts. This section is comprised of 4 sub-sections. It is the Effects section of the entire mixer and soundbanks of the Music Network Station.

first sub-section is the Gate/Limiter Controls, which controls the gate/limiter of the mixing board and the gate/limiter to any MIDI sound instrumentation that is going on, via select buttons. On every channel, this gate can be summed up. The second subsection is the compressor control section. This allows you just like the Gate, to put compressor on any mixer channel, track channel and any instrument whether it be MIDI or Audio. The third subsection is the EQ Control section. This should give you different EQ's for the mixer channels, the multi-track channel and any midi instrument that is in the Music Network Station (soundbanks). You are able to find different EQ's here, 4-band parametric EQ, a 3-band parametric EQ, a 7,15, and 31 graphic EQ and a notch filter EQ. The fourth subsection is the regular Digital FX Control section. This allows you to put effects such as reverb delay, chorus, phaser to name a few, to the mixer channels, the audio track channels and any instrument channel. So, if I pull up a piano, I should be able to strike up reverb on the effects section, and the piano should have reverb effects.

Component 3 is the Touchscreen, Keyboard and Mouse Section with Web Browser and Print to Notation Transcriber Buttons: For monitoring data entry and transport controls. Also featuring time toggle wheel and selection buttons. This section consists of a touch screen display that allows you to select and view every function of the Music Network Station. There's an alpha-numeric keyboard that is used to type data. There is a mouse section and your transport controls. Transport controls are things that control the sequencer such as you play button, your rewind button, your fast forward button, your stop button and record button and also a toggle wheel that allows you to toggle in reverse or toggle forward just like a cassette tape. Additionally, you will have some selection buttons. The selection buttons allows you to select things quickly on the touch screen that you see. For instance, if you want to go directly to pianos, you will see the word piano on the touch screen and beside that, part of the touch screen will be a select button for you to press and you are automatically taken in the piano section of the Music Network Station. The same goes for brass, bass, drums, etc. You can also search the web and print music to Notation Transcriber via button selection.

Component 4 is the Onboard Factory Sounds, Sampler, Translator, Converter, Editor and Mixer Section with write record memory technology. This is the sound bank and editor control section. This is the section where you dial up any sounds in the Music Network Station factory or sample sounds. This is where you can edit any instrument sounds and where you see a window for your sampler and wave files to your sampler. This screen will also be large enough to display the mixer section as well as stereo and mono samples. This section is also your translator section that translates samples from the Music Network Station to other keyboard brand formats and from that brand back to the Music Network Station. This Music Network Station will be able to accept samples from any keyboard where the language is programmed for it all through a sub license agreement with the company “Chicken Systems”. This is an editor section so all of your factory sounds will be dialed-up from here. This entire section no matter what you do to edit the sound, you should be able to save, write, record it into the SSD memory bank, SD flash, or Thunderbolt 3 drive. Example: If I have a piano sound and want to make the piano sound brighter, I should be able to make it brighter and that brightness be stored for total recall on the Music Network Station. Basically, any edits to the sounds can be saved. If you're recording a song and you change the timber as an example on the piano while you're recording, so in the beginning you have the piano sounding sharp with great attack, you manipulate it that way in the editor section and then maybe on the bridge of the song you decide you want the piano to have a softer attack so you edit it in the editor section, these moves can be totally recalled in sequence mode or stored in performance mode as presets or banks.

Component 5 is the 16 full sensitivity “Akai MPC drum machine style” drum pad section: The sound quality of the Akai MPC drum machine technology.

Component 6 is the “Akai MPC” style or better drum machine controller section. This section should have controls to make those drum pads work in a drum machine manner, such as drum roll button, flam button, arpeggiator button, and other important functions, like groove feel to give you a more human style of drum programming.

Component 7 is the Sound Manipulation, Pitch Bend, Modulation, and Drawbar Organ Leslie Switch Section. It includes the Modulation Wheel, Pitch Bend Wheel and (the modulation wheel that will trigger the organ's Leslie cabinet, giving it the trill sound that organs can make.

Components 61, 76, 88 comprise the Note Semi-Weighted and Full-Weighted Keyboard Sectio.

All of the controls and sections that have been discussed thus far should be included in every size version of the Music Network Station with the exception of the 61 note keyboard. The 76 and 88 note keyboard section should be able to have all sections included. The 88 note keyboard keys should be fully weighted. The 76 can be fully weighted or semi-weighted, but the 61 will be semi-weighted.

### Modulation Strip Section

It allows a user to get the same sliding effect sound as you would from a bass guitar when their finger slides up/down the string of that instrument. It also allows the user to change the pitch of a tom drum for special effects.

The 8 Channel True 32/64-bit Audio Interface Section: with mic/line gain trims, phantom power, +4 −10 selection, XLR-¼ inch combo input and TRS insert jacks with mute capabilities

This is the audio interface section. This is a True 32/64-bit audio interface section. This section includes mic/line gain trims on each 8 channel, you have phantom power on each channel or maybe groups of 4 (i.e. 1-4 phantom power and then 5-8). There is a +4 −10 selection button so you can plug in professional gear as well as semi-professional gear with the switch of a button. Additionally, this section has a combo XLR-¼ inch inputs (8 channels) jacks. There are 8 channels of TRS insert jacks that will allow you to hookup extra external effects equipment or gear to these jacks that can be muted. Instead of disconnecting them, the user can just hit the mute button via onboard software.

The HDMI, Ethernet, Vocoder, Breath Controller, and Multi-Channel Audio Output Option (the Multi-channel port's jack extensions are to be included)
This is the Ethernet and HDMI section and the optional multi-output section of the audio interface. The interface can input 8 channels simultaneously and it can output up to 24 channels at a time depending on the optional adapters you buy. There is an expandable output section for use.

Thunderbolt 3 Inputs and SD Card Section: For Computers, Printers, Flash Medium Control and all Apple, MS Windows, and Android device connectivity.

The system allows the user to hook up the Music Network Station to a computer and control it from the computer via our own external software, the same as Apple, MS Windows, and Android based devices. This will also be available through Wi-Fi, Bluetooth and Ethernet. The user can plug in flash drive mediums, such as SD Cards for all of your file transferring or even smart devices. In other words, samples should be saved in a sample folder, sequences saved in a sequence folder, console automation saved in an mixer folder, synth presets, fx and so forth to their own folders or sections. Also between numbers labels 11 and 12, there should be Bluetooth LE with zero latency multiple in/outs. Ethernet, WiFi and Apple's Thunderbolt 3 Technology with multiple in/outs.

### Legacy MIDI Port Section: In, Out and Through

Keyboard Sustain, Volume and Drawbar Organ Jack for optional Footboard Connection Section:

Can plug in optional external devices such as a footboard to a B3 organ where organists can play a footboard with their feet. Also a keyboard expansion jack for an (optional) 2^{nd} playing keyboard for a full, dual keyboard playing experience of a real Hammond by linking 2 keyboards together.

Power Supply Section: Laptop block style power supply cord, keeping the heat in the cord on the floor and not the keyboard (3 prong). Also, this should be with international switch and common adapters to change between US and other countries standards.

### The Music Network Station's Virtual Studio Room

It will allow users to collaborate in a live studio session with each other using a server based software that will be hosted by the Music Network Station's licensing company via personal accounts, through paid subscriptions. This software will be called “Centourium” Virtual Studio Room. It will be able to record, edit, mix, fx process and playback audio, synchronize video along with its software included optional in-app purchased plug-ins. It will have connectivity from external devices such as music equipment or video equipment through Ethernet, Thunderbolt 3 and HDMI(audio/video) protocols and additional external creation of a “Centourium” A/V Interface Box, which will be one of the accessories also designed.

The system includes at least the following elements: An Al/Quantum Software Operating System with a dedicated OS, powered by a latest-generation multi-core CPU architecture and discrete GPU, forms the intelligent core, managing Al tasks, sound generation, real-time processing, and providing an extensible environment for current Al/quantum-inspired applications, with a clear roadmap for future Quantum CPU integration.

### A Universal Hybrid Control Surface With Dynamic Haptic Feedback Faders (See FIG. 1)

(DHFFS) & Advanced Displays: An adaptive interface featuring touch-sensitive automated DHFFs with programmable tactile feedback, complemented by dual high-resolution AMOLED/Mini-LED touchscreens (one detachable, 120 Hz refresh rate, HDR support) and extensive assignable controls.

Deep Al Integration Across Workflow: Al fundamentally enhances composition, arrangement, sound synthesis, intelligent mixing, dynamic performance adaptation, and personalized preset generation, Al-Powered Melody-to-Arrangement & Automatic Song Generation: Sing or hum a melody, and the Al intelligently transcribes it, suggests or automatically selects the best-suited virtual instruments for the part, and can generate accompanying backing tracks or full song structures based on user-defined parameters or Al-driven stylistic analysis.

Al-Powered Song Recognition (Hum-to-Identify): Identifies cover songs or existing melodies based on user humming or singing, leveraging onboard Al and secure access to online music databases via integrated Wi-Fi, Multi-Gigabit Ethernet (RAVIN), and an optional cellular data (SIM chip) connection.

Expandable Pro-Grade Audio & Next-Gen USB-C Ecosystem: Features a high-resolution audio engine (up to 32-bit float/192 kHz processing, internal 64-bit float pathways) with 8 analog inputs/outputs with inserts. Offers extensive USB Audio Class Compliant connectivity via 5 USB-C ports (all supporting USB4 Version 2.0/Thunderbolt 5 standards), supporting 64+ channels of simultaneous audio streaming, and one port assignable for ultra-fast external NVMe storage.

Universal Plugin & Template Architecture: Designed as an open platform, offering high-quality performance pads and sampling capabilities while supporting templates and deep integration for a wide variety of popular third-party drum machine plugins, samplers, and virtual instruments.

“Centourium” Global Collaboration Suite (via RAVIN Protocol over Multi-Gigabit Ethernet): The “Centourium” Virtual Studio Room enables real-time, low-latency online collaboration worldwide, utilizing the RAVIN Protocol over Multi-Gigabit Ethernet (supporting 2.5 Gbps/5 Gbps, potentially 10 Gbps) for robust, globally interoperable communication. The system includes Al-Enhanced Expressive Performance & MIDI 2.0: Features premium Fatar keybeds with polyphonic aftertouch, a full-length polyphonic touch-sensitive modulation strip, an advanced Al-Processed Breath Controller, and full support for MIDI 2.0 protocol features.

Premium Lightweight & Durable Construction with Advanced Storage, crafted from aerospace-grade aluminum alloy, featuring ultra-fast internal NVMe PCIe Gen5 SSD storage and high-speed SD Express/CFexpress card slots.

### Detailed Features and Capabilities

The detailed features are now described.

### A. Hybrid Control & Interface

Dynamic Haptic Feedback Faders (DHFFs) which are advanced touch-sensitive, software-automated faders providing precise control and programmable haptic feedback, simulating various tactile sensations (e.g., physical fader movement, drawbar clicks, detents) without mechanical components. Feature high-resolution LED position tracking and dynamically adapt function and feedback based on the selected software module.

### Dual Advanced Touchscreens

Main vibrant AMOLED or Mini-LED high-resolution (e.g., QHD+ or 4K) multi-touch display with a high refresh rate (e.g., 120 Hz) and HDR support for primary system control. Second detachable display with similar high-quality screen technology, maintaining full wireless/wired connectivity.

### Versatile Performance Pads

16 full-sensitivity, RGB backlit performance pads, optimized for triggering samples, drums, clips, and sequences. Supports user-configurable templates for seamless workflow integration with various drum machine and sampler plugins (including Akai MPC style and others).

### B. Al/Quantum Software Operating System & Processing

The Centourium AIQ plus Workstation Keyboard is powered by a custom-built, real-time Al/Quantum Software Operating System. This OS manages all hardware resources and is driven by a latest-generation, high-performance multi-core CPU architecture (potentially an advanced System-on-Chip (SoC) with integrated Neural Processing Units—NPUs—for Al acceleration) and a discrete, powerful GPU for advanced graphics rendering on the dual touchscreens and further Al computation acceleration. It is architected for modularity and future integration of Quantum Processing Units (QPUs).

The Al Engine: provides comprehensive Al assistance including: context-aware compositional tools; generative sound design; intelligent audio analysis for mixing and mastering suggestions; adaptive performance tools that can learn and respond to playing style; and advanced preset management and discovery.

The melody-to-instrument and song generation component of the invention analyzes sung or hummed vocal melodies, transcribes them accurately into MIDI or other musical data, and offers intelligent instrument suggestions (e.g., “this melody would suit a cello” or “a lead synth”) based on melodic contour, rhythm, and implied harmony. Provides options for automatic song arrangement, generating chord progressions, basslines, and drum patterns that complement the input melody, with user control over complexity, genre, instrumentation, and overall song structure. Users can opt for fully automatic creation or manually select and refine Al-generated parts.

The song Identification (Hum-to-Identify): Utilizes advanced audio analysis, pitch tracking, and Al pattern matching algorithms to identify songs hummed, sung, or played by the user. The system leverages secure, high-speed connectivity (Wi-Fi, Multi-Gigabit Ethernet, optional integrated cellular data via SIM card) to query extensive online music recognition databases and/or locally cached databases for rapid and accurate identification of existing musical works or cover songs.

The inventive methods quantum-inspired algorithms currently utilizes quantum-inspired algorithms on its high-performance classical processors for optimization problems, complex simulations in sound modeling, and enhancing Al learning efficiency, paving the way for native quantum algorithms with future QPU integration.

### C. Sound Generation & Manipulation

The system's onboard sound engine and universal plugin host includes and extensive library of high-quality, expandable factory sounds. Functions as an open and universal host for a wide array of third-party virtual instruments, samplers, and effects plugins, with Al-assisted control mapping and resource management.
The advanced vocoder is an Al-enhanced vocoder with polyphonic capabilities, real-time harmony generation, intricate formant sculpting, and voice transformation effects.

### D. Performance & Expressivity

The system keyboard options includes 61, 76, and 88-key versions with premium Fatar keybeds, offering choices of semi-weighted and fully-weighted actions, all featuring polyphonic aftertouch.

Another performance enhancement module is the Al-Processed Breath Controller, a highly sensitive and configurable breath controller input, coupled with a sophisticated Al processing engine. This system allows for exceptionally realistic and nuanced emulation of a vast range of acoustic instruments (wind, brass, strings, and even percussive or vocal articulations) by translating breath, lip pressure (if applicable via compatible accessories), and other subtle inputs into complex multi-parameter sound modulations. It goes far beyond simple volume or filter control, enabling deeply expressive, organic performances. A Polyphonic Touch-Sensitive Modulation Strip is a full-length strip positioned above the keys for polyphonic expressive control.

MIDI 2.0 Support: Full support for the MIDI 2.0 protocol, including high-resolution velocity and controllers, per-note pitch bend, articulation data, and property exchange, implemented across USB, Ethernet (RAVIN), and wireless connections, alongside legacy 5-pin DIN MIDI ports for universal compatibility.

### E. Connectivity & Networking

The modules include an audio interface which is a professional-grade, USB Audio Class compliant audio interface. An analog I/O series of input terminals include 8 analog inputs (Neutrik™ XLR/TRS combo jacks) with high-end microphone preamplifiers, individual phantom power, gain control, and analog insert points (TRS) on each input. 8 balanced analog line outputs (TRS).

The system supports audio resolutions up to 32-bit float/192 kHz A/D/A conversion, with internal 64-bit float processing pathways for maximum fidelity and headroom. Architecture designed for future audio standard advancements.

Regarding data transfer and peripherals, connection for high-speed MIDI controllers, accessories, and multi-display setups via DisplayPort alternate mode.

A provided dedicated ultra-fast storage port is optimized for ultra-fast connection to external NVMe SSDs via Thunderbolt 5/USB4 for massive sample libraries, project storage, and system backup.

Wired Network (Upgraded): Multi-Gigabit Ethernet port (supporting NBASE-T standards for 2.5 Gbps/5 Gbps and potentially 10 Gbps speeds) utilizing the RAVIN Protocol (Real-time Audio Visual Interactive Network).

Wireless Network (Upgraded): Latest generation Wi-Fi 7 (IEEE 802.11be) for high-bandwidth, low-latency wireless networking. Bluetooth 5.4 supporting Bluetooth LE Audio with Auracast™ broadcast audio capabilities, and high-resolution audio codecs (e.g., aptX Lossless, LDAC) as well as low-latency MIDI profiles.

The system includes optional cellular data connectivity via an Integrated SIM card slot supporting 4G LTE/5G mobile data connectivity, enabling standalone internet access for online collaboration, song recognition databases, cloud-based sample libraries, and system/software updates when Wi-Fi or wired Ethernet are unavailable.

Other Ports provided by the system include multiple assignable footswitch/expression pedal inputs, dedicated headphone outputs with independent amplification.

### F. “Centourium” Virtual Studio Room

The system allows for global real-time collaboration cloud-based platform enabling multiple users worldwide to collaborate live on projects with minimal latency. Features include synchronized multi-track audio recording via the RAVIN protocol, MIDI sequencing, shared plugin instances, distributed mixing, real-time effects processing, and integrated video chat/streaming for visual collaboration.

### G. System & Build

Material: Main chassis precision-milled from a single block or assembled from aerospace-grade aluminum alloy (e.g., 6061 or 7075 series) for optimal strength-to-weight ratio, durability, and thermal dissipation, with a premium anodized finish.
Internal Storage (Upgraded): Ultra-fast internal NVMe PCIe Gen5 SSD storage for the OS, core sound libraries, and frequently accessed projects.

Card Slot (Upgraded): High-speed card slot supporting SD Express and/or CFexpress Type B/C standards for additional storage and data transfer.

From the foregoing description, one skilled in the art can easily ascertain the essential characteristics of this invention and, without departing from the spirit and scope thereof, can make various changes and modifications of the invention to adapt it to various usages and conditions.

It is to be understood that the present invention is not limited to the sole embodiment described above, but encompasses any and all embodiments within the scope of the following claims:

1. AI-Powered Keyboard Workstation: A keyboard workstation comprising a music network station (M.N.S.) that necessarily integrates artificial intelligence (AI) and a multi-core processor to provide advanced music creation, performance, and collaboration capabilities not available in conventional workstations.

2. Dual Touchscreen Interface with Haptic Feedback: A keyboard workstation as in claim 1,
distinguished by a first touchscreen for controlling overall parameters and a second touchscreen dedicated to sample wave editing, synthesis, and drum programming, both incorporating haptic feedback for enhanced user interaction.

3. AI-Powered Smart Mixing: A keyboard workstation as in claim 1,
wherein the AI actively analyzes user performance in real-time and autonomously adjusts audio mixing parameters, including levels, EQ, panning, and dynamics processing.

4. AI-Assisted Composition: A keyboard workstation as in claim 1,
wherein the AI provides novel assistance in music composition by generating melodies, harmonies, rhythms, and complete song sections based on user input or preferences, going beyond simple accompaniment or suggestion features.

5. AI-Driven Sound Manipulation: A keyboard workstation as in claim 1,
wherein the AI uniquely powers sound manipulation tools, including granular synthesis, neural network-based instrument emulation, and real-time sonic morphing, all accessible and controllable through the second touchscreen with haptic feedback.

6. AI-Powered Drum Programming: A keyboard workstation as in claim 1,
wherein the AI generates complex and nuanced drum patterns, grooves, fills, and entirely new drum sounds, all programmable and editable through the second touchscreen with haptic feedback.

7. AI-Powered Adaptive Learning: A keyboard workstation as in claim 1,
wherein the AI continuously learns user playing styles and preferences over time, dynamically adapting its responses, suggestions, and user interface personalization to optimize workflow.

8. AI-Enhanced Hybrid Control Surface: A keyboard workstation as in claim 1,
further comprising a hybrid control surface with AI-assisted automated mixer sliders and drawbars that intelligently provide haptic feedback and adapt in real-time to user input.

9. AI-Powered Expanded Breath Control: A keyboard workstation as in claim 1,
further comprising breath control integration for any instrument using specialized sensors and adaptive mouthpieces, with AI algorithms precisely translating breath into expressive musical gestures beyond traditional breath controllers.

10. AI-Driven Advanced Vocoder Integration: A keyboard workstation as in claim 1,
further comprising advanced vocoder capabilities with formant shifting, harmonizing, robotic voice effects, and AI-driven vocal processing that not only suggests harmonies but also generates backing vocals.

11. AI-Enhanced Real-time Collaboration: A keyboard workstation as in claim 1,
further comprising ultra-low latency audio and video streaming powered by AI for unprecedented collaborative music creation with other users, minimizing latency issues common in existing systems.

12. AI-Powered Cloud-Based Project Management: A keyboard workstation as in claim 1,
further comprising cloud-based project storage, management, and access with AI-assisted version control and collaborative editing features that streamline workflow and enhance productivity.

13. AI-Driven Music Production Tools: A keyboard workstation as in claim 1,
further comprising integrated AI tools that actively assist in songwriting, arranging, mixing, and mastering, offering advanced capabilities beyond basic automation.

14. Enhanced Connectivity: A keyboard workstation as in claim 1,
further comprising a comprehensive I/O interface with HDMI, Ethernet, Thunderbolt 3, traditional MIDI ports, and multi-channel audio outputs;
wireless connectivity options, including Bluetooth LE and Wi-Fi; and
compatibility with a universal LAN or Ethernet protocol for significantly expanded audio and visual connectivity, surpassing the limitations of Dante or HiQnet protocols.

15. High-Performance Processing: A keyboard workstation as in claim 1,
wherein the multi-core processor is a silicon-based or NVIDIA-based chip specifically chosen for its future-proof quality, quantity, and processing power essential to support the AI and advanced features of the workstation.

16. Future Quantum Processing Upgrade: A keyboard workstation as in claim 1,
further comprising the potential for future integration of a quantum processing unit (QPU) alongside or in replacement of the multi-core processor, enabling even more advanced AI capabilities and real-time processing of complex musical data as quantum technology matures and stabilizes.

17. Hybrid Quantum-Classical Computing Architecture: A keyboard workstation as in claim 16,
wherein the QPU and the classical multi-core processor operate in a hybrid architecture, leveraging the strengths of both quantum and classical computing paradigms to optimize AI algorithms and music processing tasks.

18. Quantum-Enhanced AI for Music Creation: A keyboard workstation as in claim 16,
wherein the QPU enhances the AI capabilities by enabling faster and more efficient processing of complex musical data, leading to improved real-time performance analysis, sound manipulation, and AI-assisted composition features.

19. Quantum-Accelerated Machine Learning: A keyboard workstation as in claim 16,
wherein the QPU accelerates the training and execution of machine learning models used for adaptive learning, personalized user interfaces, and other AI-driven features.

20. Quantum-Inspired Sound Design: A keyboard workstation as in claim 16,
wherein the QPU enables the creation of novel sound design tools and effects based on quantum phenomena and algorithms, leading to unique sonic possibilities not achievable with classical computing.
